(19) United States
(12) Patent Application Publication
(10) Pub. No.: US 2008/0144535 A1
(43) Pub. Date: Jun. 19, 2008

(54) RING-TYPE NETWORK AND FAIRNESS EXECUTION PROGRAM FOR RING-TYPE NETWORK

(75) Inventor: Toshiro YAMAUCHI, Tokyo (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 11/952,154

(22) Filed: Dec. 7, 2007

(30) Foreign Application Priority Data
Dec. 13, 2006 (JP) 2006-335959

(51) Int. Cl. H04L 12/28

(52) U.S. Cl. 370/258

(57) ABSTRACT

To obtain ring-type network that is capable of sensing a change in the structure of a lower layer network when there is a change, and to obtain a fairness execution program for the ring-type network, which can implement the fairness function in a fine manner even in such case. Each of RPR devices of an RPR network includes a timer, and transmits a periodic transmission request of an LRTT control frame to an LRTT control frame transmitter via an arbitrating part so that the transmitter sends the LRTT control frame to each RPR device regularly. An LRTT control frame receiver receives the returned LRTT control frame, and a round trip propagation time calculator calculates round trip propagation time from a difference between the transmitted time and the received time, and gives the result to a fairness execution part. Thereby, a fine operation of the fairness function is secured.

### CROSS-REFERENCE TO RELATED APPLICATION

This application is based upon and claims the benefit of priority from Japanese patent application No. 2006-335959, filed on Dec. 13, 2006, the disclosure of which is incorporated herein in its entirety by reference.

### BACKGROUND OF THE INVENTION

1. Field of the Invention

The present invention relates to a ring-type network and a fairness execution program for the ring-type network. More specifically, the present invention relates to a ring-type network that has a function of measuring round trip propagation time of the ring-type network (in which communications are performed via nodes), when there is a change in the structure of the nodes that configure a network such as an SDH with a protection function, and also to a fairness execution program for executing fairness processing of the ring-type network by using the loop round trip time measured between each of the nodes.

2. Description of the Related Art

There are cases where nodes that configure each network are connected on a network such as an SDH (Synchronous Digital Hierarchy) network that has a protection function so as to form a ring-type network. A case of building an RPR (Resilient Packet Ring) network on the SDH network is an example of such cases.

Particularly, the RPR network has such advantages that the ring bands of each node can be utilized fairly, and that all the duplicated bands can be utilized to the fullest when the bands are not used by other nodes. Further, the RPR network has gain an attention in terms of the reliability and fault tolerance of the network (see Japanese Unexamined Patent Publication 2005-159701 (paragraph 0008, FIG. 1), for example (Patent Document 1).

FIG. 5 shows an RPR network as an example of a ring-type network built on a related network with a protection function. In this example, an RPR network 100 is built on an SDH network 101.

In this example shown in FIG. 5, a first RPR device 102₁ configuring the RPR network 100 is connected to a second RPR device 102₂ via a first SDH device 103₁ and a second SDH device 103₂. Further, the second RPR device 102₂ is connected to a third RPR device 102₃ via the second SDH device 103₂ and a third SDH device 103₃. Furthermore, the third RPR device 102₃ is connected to a fourth RPR device 102₄ via the third SDH device 103₃ and a fourth SDH device 103₄, and the fourth RPR device 102₄ is connected to the first RPR device 102₁ via the fourth SDH device 103₄ and the first SDH device 103₁. In this manner, the RPR network 100 is built on the SDH network 101.

In the RPR network 100 as shown in FIG. 5, the SDH network 101 normally has a protection function. That is, if there is a fault occurred in one of communication paths, the SDH network 101 autonomously changes the communication paths by the protection function so that communication can be achieved by avoiding the point of the fault.

When the SDH network 101 changes its paths by the protection function as described above, signal propagation paths among the first-fourth RPR devices 102₁-102₄ connected to the network are changed. Further, in accordance with this, signal propagation time between the first-fourth RPR devices 102₁-102₄ becomes changed as well.

For example, under a state with no protection function of the SDH network 101 being implemented, the first RPR device 102₁ and the second RPR device 102₂ are connected through a path that connects the first SDH device 103₁ and the second SDH device 103₂. When there is a fault occurred between the first SDH device 103₁ and the second SDH device 103₂, the protection function of the SDH network 101 changes the transmission paths of the network such that the first RPR device 102₁ and the second RPR device 102₂ are connected through a path that connects the first SDH device 103₁, the fourth SDH device 103₄, the third SDH device 103₃, and the second SDH device 103₂ in this order. The path on the SDH network 101 connecting the first RPR device 102₁ and the second RPR device 102₂ is changed before and after implementing the protection function. Thus, round trip propagation time of a signal transmitted between the first RPR device 102₁ and the second RPR device 102₂ becomes changed as well before and after implementing the protection function of the SDH network 101.

However, such changes in the SDH network 101 caused due to the SDH protection function are generated inside the SDH network 101. Therefore, the first RPR device 102₁ and the second RPR device 102₂ which are provided outside the SDH network 101 can not recognize the changes in the SDH network 101. Thus, when the RPR devices such as the first-fourth RPR devices 102₁-102₄ are connected via the SDH network 101, normally, changes occur in the SDH network 101 without giving any notice about the changes to the RPR devices. Thus, the propagation time of a signal transmitted between the RPR devices such as the first-fourth RPR devices 102₁-102₄ becomes changed even though the structure itself of the RPR network 100 is unchanged.

Each of the first-fourth RPR devices 102₁-102₄ measures the round trip propagation time LRTT (loop round trip time) of a signal between itself and another device in order to achieve the optimum operation of a fairness function that is defined by IEEE (The Instituted of Electrical and Electronics Engineers, Inc) 802.17. Specifically, the first RPR device 102₁, for example, measures the round trip propagation time of a signal between itself and the second RPR device 102₂, the third RPR device 102₃, and the fourth RPR device 102₄.

In the RPR device of a related art, the round trip propagation time is measured only when the structure of the RPR network 100 is changed, i.e. only when a connection state among the first to fourth RPR device 102₁-102₄ is changed in the case of FIG. 5. When there is a change in the SDH network 101 in this case, the structure itself of the RPR network as a lower network does not change. As in the case described above, connection between the first RPR device 102₁ and the second RPR device 102₂ does not change even if the protection function of the SDH network 101 is implemented. Therefore, even if there is a change in the round trip propagation time LRTT (loop round trip time) of the signal caused due to the protection action of the SDH network 101, the RPR network 100 does not re-measure the round trip propagation time. As a result, it is not possible for the RPR network 100 itself to recognize the change in the round trip propagation time LRTT of the signal generated among the first-fourth RPR devices 102₁-102₄ caused due to occurrence of a fault in the SDH network 101.

Specifically, the signal round trip propagation time LRTT is obtained by measuring the time required for an LRTT control frame to be sent to another RPR device and for the sent LRTT control frame to be returned. If the round trip propagation time LRTT of the signal between the RPR devices is changed without having a change in the RPR network 100, there is a difference generated between the actual signal round trip propagation time and the signal round trip propagation time recognized by the RPR devices. Thus, the fairness function does not work optimally.

The RPR network 100 built on the SDH network 101 has been described above. However, it is not limited only to that. Normally, in a ring-type network built on a network with a protection function, there is also a difference generated between the actual signal round trip propagation time and the signal round trip propagation time recognized by the nodes that configure the ring-type network, when the round trip propagation time of the ring-type network that performs communications via the nodes becomes changed due to a change in the structure of the network that has the protection function. As described, when there is a change in the network of a lower layer, the fairness function cannot be operated optimally because of that.

### SUMMARY OF THE INVENTION

An exemplary object of the present invention therefore is to provide a ring-type network capable of recognizing a change in a network of a lower layer when a change occurs, and to provide a fairness execution program for the ring-type network, which enables a fairness function to be implemented in a fine manner even in such case.

A ring-type network according to a first exemplary aspect of the invention includes (a) a plurality of first nodes on a prescribed base network that is capable of freely changing signal transmission paths between the first nodes, and a plurality of second nodes arranged in a ring-like form on the prescribed base network, each of the second nodes being connected to optional ones among the first nodes, wherein each of the second nodes includes: (b) a periodic measurement signal transmitting device which repeatedly transmits, with a time lag, a periodic measurement signal for measuring round trip propagation time to each of the second nodes other than own second node; (c) a periodic measurement signal returning device which returns the periodic measurement signal to the second node as a sender, when the periodic measurement signal is transmitted from the periodic measurement signal transmitting device belonging to the second node other than the own second node; (d) a periodic measurement signal receiving device which receives the periodic measurement signal returned from the periodic measurement signal returning device belonging to the second node other than the own second node; and (e) a periodic-measurement round trip propagation time measuring device which measures round trip propagation time of the periodic measurement signal between the second nodes by finding a difference between received time of the periodic measurement signal received at the periodic measurement signal receiving device and transmitted time at which the periodic measurement time signal is transmitted from the periodic measurement signal transmitting device.

That is, according to the first exemplary aspect of the invention, a ring-type network is built on a base network. Note here that there are a plurality of first nodes in the base network, and the ring-type network includes a plurality of second nodes each connected to optional ones among the first nodes. Each of the second nodes in the ring-type network repeatedly transmits, with a time lag, the periodic measurement signal for measuring round trip propagation time to the second nodes other than the own second node. When this periodic measurement signal reaches the corresponding second node, it is returned from that second node to the own second node. Therefore, each of the second nodes can collect the periodic-measurement round trip propagation time (calculated from a difference between the transmitted time at which the periodic measurement signal is transmitted and the time at which the signal is returned) by each second node. Thus, it is possible to monitor changes in the periodic-measurement round trip propagation time by each second node.

As an exemplary advantage according to the invention, with the monitoring described above, it is possible to measure the round trip propagation time between the second nodes when there is a change in the structure of the ring-type network that is configured with the plurality of second nodes. However, it is also possible to provide a structure change identifying device separately to the ring-type network for identifying a change in the structure, so as to separately measure the round trip propagation time between the second nodes when the structure change identifying device identifies a change in the structure of the ring-type network.

The result of measurements on the round trip propagation time between the second nodes obtained in this manner can be utilized to rebuild a fairness function that is defined in IEEE802.17. Thus, the optimum fairness function can be executed. That is, each of the second nodes can optimally and continuously execute the fairness function by using the proper round trip propagation time.

When there is contention in terms of time between the two kinds of round trip propagation time, it may be arbitrated to execute only one of the measurements at that point. The base network may include a protection function for enabling communications by changing the signal transmission paths among the first nodes to avoid a fault. For example, the base network may be an SDH network. In that case, an RPR network that is a ring-type network may be built on the SDH network.

According to a second exemplary aspect of the invention, a fairness execution program for a ring-type network includes a plurality of first nodes on a prescribed base network that has a protection function for enabling communications by avoiding a fault through properly changing signal transmission paths among the first nodes, and a plurality of second nodes arranged in a ring-like form around the prescribed base network, each of the second nodes being connected to optional ones among the first nodes on the prescribed base network, and the program allows a computer provided to each of the second nodes to execute: (a) a periodic measurement signal transmitting processing which repeatedly transmits, with a time lag, a periodic measurement signal for measuring round trip propagation time to each of the second nodes other than the own second node; (b) a periodic measurement signal returning processing which returns the periodic measurement signal to the second node as a sender, when the periodic measurement signal is transmitted by the periodic measurement signal transmitting processing from the second node other than the own second node;(c) a periodic measurement signal receiving processing which receives the periodic measurement signal returned by the periodic measurement signal returning processing from the second node other than the own second node; (d) a periodic-measurement round trip propagation time measuring processing which measures round trip propagation time of the periodic measurement signal between the second nodes by finding a difference between received time of the periodic measurement signal received in the periodic measurement signal receiving processing and transmitted time at which the periodic measurement time signal is transmitted by the periodic measurement signal transmitting processing; and (e) fairness execution processing which executes a fairness function by using a result of the periodic-measurement round trip propagation time measuring processing.

That is, according to the second exemplary aspect of the invention, the computer in each of the second nodes executes the first exemplary aspect of the invention as a fairness execution program.

As described above, according to the exemplary aspect of the invention, each of the second nodes in the ring-type network built on the prescribed base network repeatedly measures, with a time lag, the round trip propagation time between the own second node and the other second nodes individually. With this, measurements of the round trip propagation time between each of the second nodes when there is a change in the structure of the network can be omitted, depending on the circumstances. Thus, a detecting device used therefore becomes unnecessary. Further, it is also possible to detect occurrences of faults by repeating the measurements of the round trip propagation time between each of the second nodes with a time lag. Needless to say, the optimum operations in communications between the nodes can be achieved through continuously checking the round trip propagation time between each of the second nodes.

### BRIEF DESCRIPTION OF THE DRAWINGS

FIG. 1 is a block diagram showing a structure of an RPR network according to a first exemplary embodiment of the present invention;

FIG. 2 is a block diagram showing the main part of a first RPR device according to the exemplary embodiment;

FIG. 3 is a flowchart showing a control state of an LRTT control frame transmitter within the first RPR device of the exemplary embodiment;

FIG. 4 is a flowchart showing a state of processing executed by the LRTT control frame transmitter and a round trip propagation time calculator according to the exemplary embodiment; and

FIG. 5 is a block diagram showing a structure of an RPR network of a related art.

### EXEMPLARY EMBODIMENTS

Hereinafter, exemplary embodiments of the present invention will be described in detail by referring to the accompanying drawings.

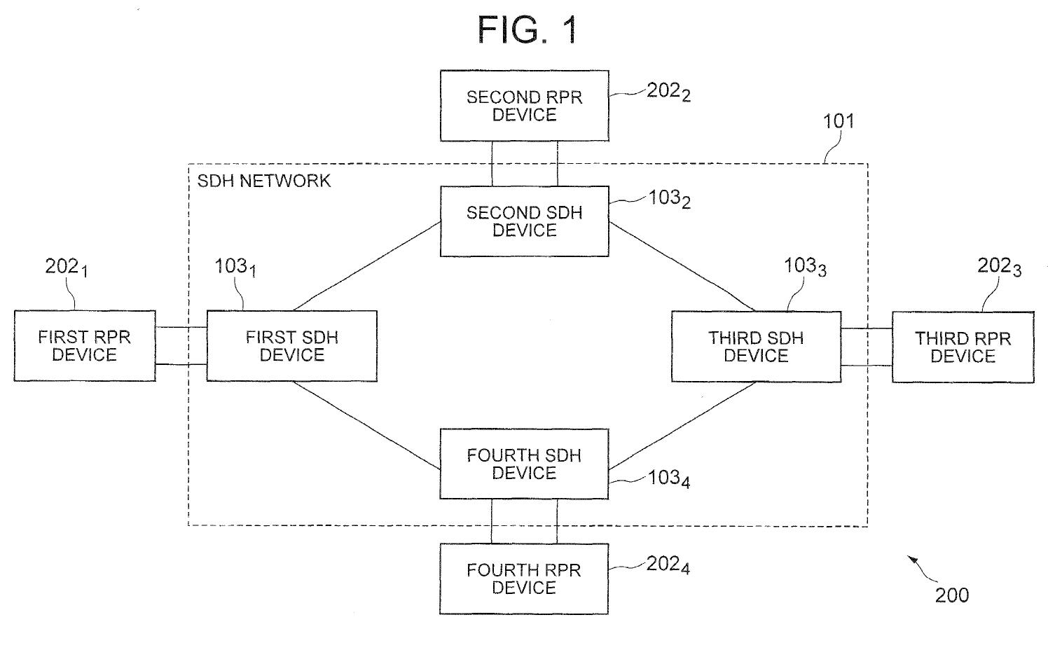

As shown in FIG. 1, a network system according to an exemplary embodiment of the present invention includes, as a basic structure: a ring-type network (200) in which a plurality of nodes for configuring a network are linked to each other; and a base network (101) that is capable of changing signal transmission paths between each of the nodes within the network, wherein the nodes (202₁, 202₂, 202₃, and 202₄) of the ring-type network (200) perform signal transmissions between each of the linked nodes, and monitor signal propagation time before and after a change in the path through which the signal transmission is performed.

Further, the nodes monitor the signal propagation time by identifying a change in the structure of the ring-type network. Furthermore, the nodes execute a communication fairness function by using data of the signal propagation time.

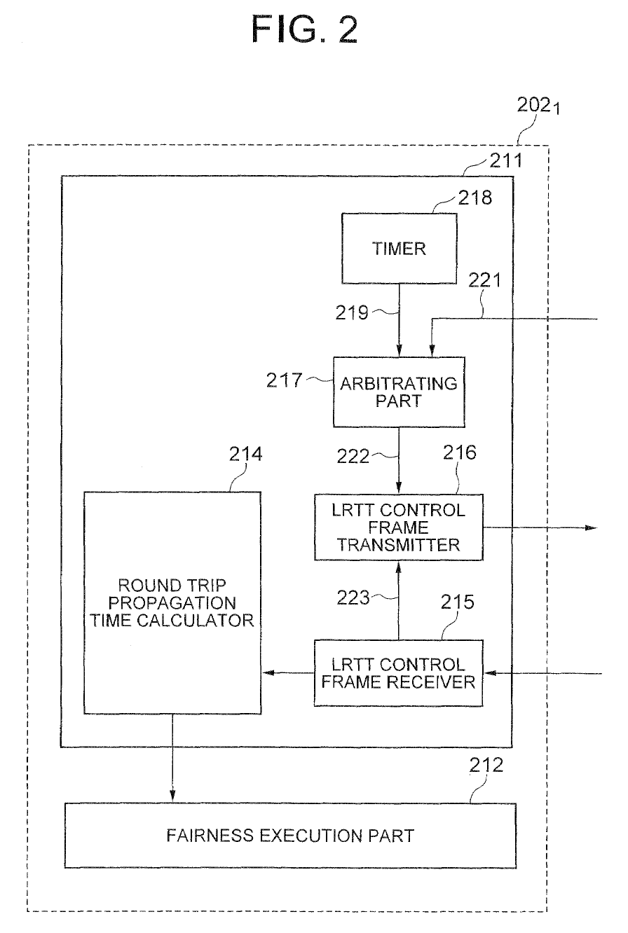

Among the nodes (202₁, 202₂, 202₃, and 202₄) which configure the network by being linked in the ring-type network (200), the signal transmission paths between the linked nodes can be changed by the base network (101) As shown in FIG. 2, each of the nodes (202₁, 202₂, 202₃, and 202₄) is formed as a structure to perform signal transmissions between the node itself and the linked node and to monitor the signal propagation time before and after a change in the path through which the signal transmission is performed.

In the exemplary embodiment of the present invention, as shown in FIG. 1, the plurality of nodes (202₁, 202₂, 202₃, and 202₄) perform signal transmissions between the nodes (the nodes 202₁ and 202₂in the case of FIG. 1) which are linked within the ring-type network (200). Further, as shown in FIG. 2, the nodes (202₁, 202₂, 202₃, and 202₄) monitor the signal propagation time before and after a change made by the base network in the path through which the signal transmission is performed. In this case, the nodes (202₁, 202₂, 202₃, and 202₄) may monitor the signal propagation time by identifying the change in the structure of the ring-type network (200) Moreover, as shown in FIG. 2, the nodes (202₁, 202₂, 202₃, and 202₄) execute a communication fairness function by using data of the signal propagation time.

In the exemplary embodiment of the present invention, the nodes of the ring-type network built on the base network monitor the round trip propagation time of a signal between the node itself and a partner node that is linked thereto. Therefore, it is possible with the exemplary embodiment to know the propagation time of the signal transmitted via the base network. This makes it possible to achieve the optimum communication between the nodes.

### First Exemplary Embodiment

Next, described by referring to FIG. 1 and FIG. 2 is a first exemplary embodiment of a network system that is built by using the SDH (synchronous Digital Hierarchy) network 101 as a base network and using the RPR (Resilient Packet Ring) network 200 as a ring-type network. Further, RPR devices 202₁, 202₂, 202₃, and 202₄ are used as the nodes included in the ring-type network 200, and SDH devices 103₁, 103₂, 103₃, and 103₄ are used as the nodes included in the base network 101.

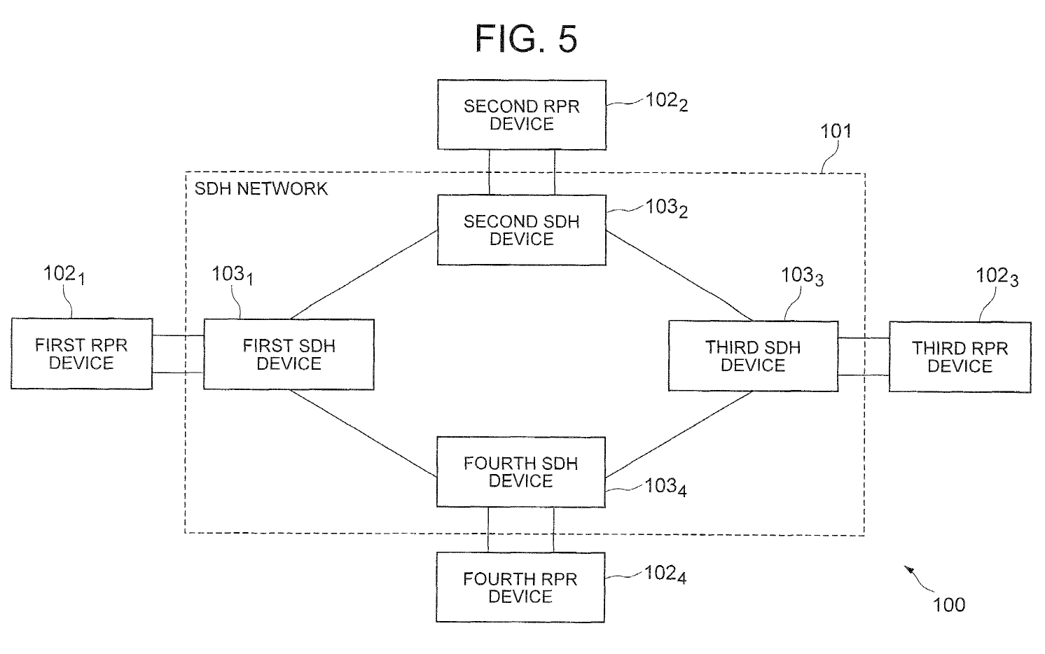

FIG. 1 shows the structure of the RPR network according to the first exemplary embodiment of the present invention. Same reference numerals are applied to the same components in FIG. 1 and FIG. 5, and redundant explanations are omitted as appropriate. The RPR network 200 of this exemplary embodiment is formed by arranging first to fourth RPR devices 202₁-202₄ on the existing SDH network 101 shown in FIG. 5. The first RPR device 202, is connected to the second RPR device 202₂ via the first SDH device 103₁ and the second SDH device 103₂. Further, the second RPR device 202₂ is connected to the third RPR device 202₃ via the second SDH device 103₂ and the third SDH device 103₃. Furthermore, the third RPR device 202₃ is connected to the fourth RPR device 202₄ via the third SDH device 103₃ and the fourth SDH device 103₄, and the fourth RPR device 202₄ is connected to the first RPR device 202₁ via the fourth SDH device 103₄ and the first SDH device 103₁. In this manner, the RPR network 200 is built on the SDH network 101.

FIG. 2 shows the main part of the first RPR device according to the exemplary embodiment. The second-fourth RPR devices 202₂-202₄ substantially have the same structure as that of the first RPR device 202₁. Thus, the specific illustrations and explanations of the second-fourth RPR devices 202₂-202₄ will be omitted.

The first RPR device 202₁ includes, inside thereof, a round trip propagation time measuring device 211 for measuring round trip propagation time, and a fairness execution part 212 for achieving a fairness function that is defined in IEEE 802.17 The round trip propagation time measuring device 211 includes: a round trip propagation time calculator 214 for measuring the round trip propagation time between itself and the second-fourth RPR devices 202₂-202₄ shown in FIG. 1; an LRTT control frame receiver 215 for receiving an LRTT control frame; an LRTT control frame transmitter 216 for transmitting the LRTT control frame; an arbitrating part 217 connected to the LRTT control frame transmitter 216; and a timer 218 connected to the arbitrating part 217.

The timer 218 is configured to output a periodic transmission request 219 of an LRTT control frame to the arbitrating part 217 regularly. The arbitrating part 217 is to receive inputs of both the periodic transmission request 219 of the LRTT control frame and a structure-changed-state transmission request 221 that is sent from a network structure change identifying part (not shown) when it is recognized that the structure of the network has been changed.

When there is contention in terms of time between the periodic transmission request 219 and the structure-changed-state transmission request 221, the arbitrating part 217 arbitrates those requests and selects one. Further, in other cases, the arbitrating part 217 let the periodic transmission request 219 and the structure-changed-state transmission request 221 pass therethrough so that the requests are inputted to the LRTT control frame transmitter 216 as transmission requests 222.

When the transmission request 222 is sent from the arbitrating part 217, the LRTT control frame transmitter 216 transmits LRTT control frames to the second-fourth RPR devices 202₂-202₄ as other RPR devices. The LRTT control frame has the transmitted time of the LRTT control frame written therein when being transmitted.

The LRTT control frame receiver 215 receives the LRTT control frames returned from the other RPR devices. At this time, the respective transmitted time and received time of the LRTT control frame at the second-fourth RPR devices 202₂-202₄ are given to the round trip propagation time calculator 214. The round trip propagation time calculator 214 uses the transmitted time and received time to calculate the round trip propagation time between the first RPR device 202₁ and the second-fourth RPR devices 202₂-202₄.

There is also a case where the LRTT control frame receiver 215 receives LRTT control frames that are originally transmitted from the second-fourth RPR devices 202₂-202₄. In that case, the LRTT control frame receiver 215 reorganizes such LRTT control frame into a transmission frame 223, and sends it out to the LRTT control frame transmitter 216. The LRTT control frame transmitter 216 executes processing for returning it to the device (sender device) that has transmitted the frame among the second-fourth RPR devices 202₂-202₄. With this, the LRTT control frame 223 of the sender device is given to the round trip propagation time calculator of the receiver device to calculate the round trip propagation time.

Referring to FIG. 2, there has been described that the arbitrating part 217 is provided to perform arbitration between the periodic transmission request 219 and the structure-changed-state transmission request 221 as necessary. However, such arbitrating part 217 and the network structure change identifying part described above may be omitted. That is, if the interval of the LRTT control frames transmitted by the timer 218 for allowing the first RPR device 202, to monitor the second-fourth RPR devices 202₂-202₄ is sufficiently short, it is possible, by repeatedly and continuously transmitting the LRTT control frames, to omit the transmission processing of the LRTT control frame which is executed based on judgments by the network structure change identifying part that there is a change in the structure of the RPR network 200.

The fairness execution part 212 and each part inside the round trip propagation time measuring device 211 described above may be configured with hardware. Alternatively, each of those parts may be achieved functionally by executing control programs stored in a recording medium (not shown) by a CPU (not shown). Further, both hardware and software may be provided in a mixed manner.

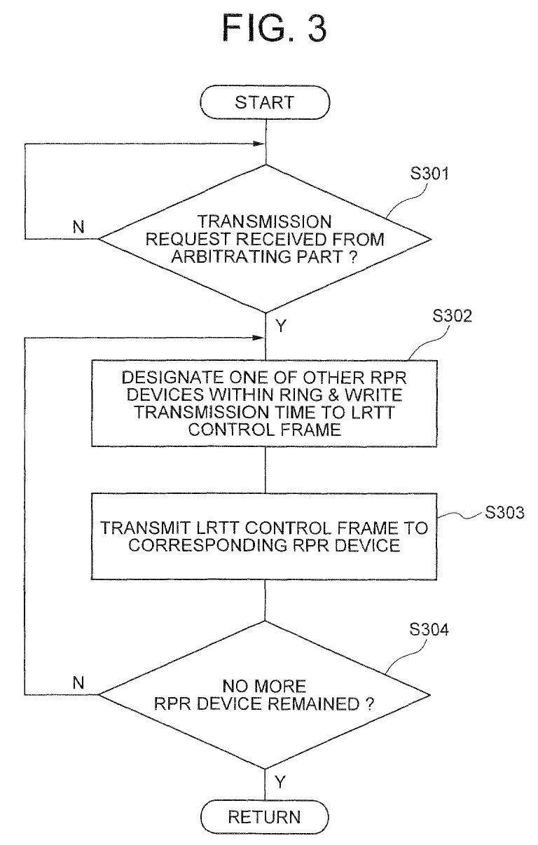

FIG. 3 shows the state of controls of the LRTT control frame transmitter within the first RPR device. Controls of the second-fourth RPR devices 202₂-202₄ shown in FIG. 1 are substantially the same. FIG. 1 and FIG. 2 will be described together. The LRTT control frame transmitter 216 waits for the transmission request 222 of the LRTT control frame transmitted from the arbitrating part 217 (step S301). Upon receiving the transmission request 222 (Y) the first RPR device 202₁ designates one of the second-fourth RPR devices 202₂-202₄ within the same ring, and writes, to the LRTT control frame, the current time obtained from a clock circuit (not shown) as the time at which the frame is transmitted (step S302). Then, the LRTT control frame is transmitted to a corresponding RPR device 202 (step S303). If there is some time between the point of writing the transmitted time to the LRTT control frame and the point of transmitting that frame, a scheduled transmission time may be written to the LRTT control frame so that it will be transmitted at that time. Further, prescribed delay time may be added to the current time obtained from the clock circuit to perform the transmission processing.

After transmitting the LRTT control frame to one of the second-fourth RPR devices 202₂-202₄ within the same ring in the manner described above, it is checked if there are any devices among the second-fourth RPR devices 202₂-202₄ which have not received the LRTT control frame (step S304). If there are any remained (N), the procedure is shifted to step S302 to select one of the RPR devices 202, and write the transmission time to the LRTT control frame to be transmitted to the selected one. Then, the LRTT control frame is transmitted to that RPR device 202.

After transmitting the LRTT control frame to all of the second-fourth RPR devices 202₂-202₄ within the same ring in this manner (step S304: Y), the procedure is returned again to step S301 to wait for the transmission request 222 of the LRTT control frame to be transmitted from the arbitrating part 217 (return). In this manner, the first RPR device 2021 performs the processing to transmit the LRTT control frame in order to the second-fourth RPR devices 202₂-202₄ within the same ring every time there is the transmission request 222 of the LRTT control frame transmitted from the arbitrating part 217.

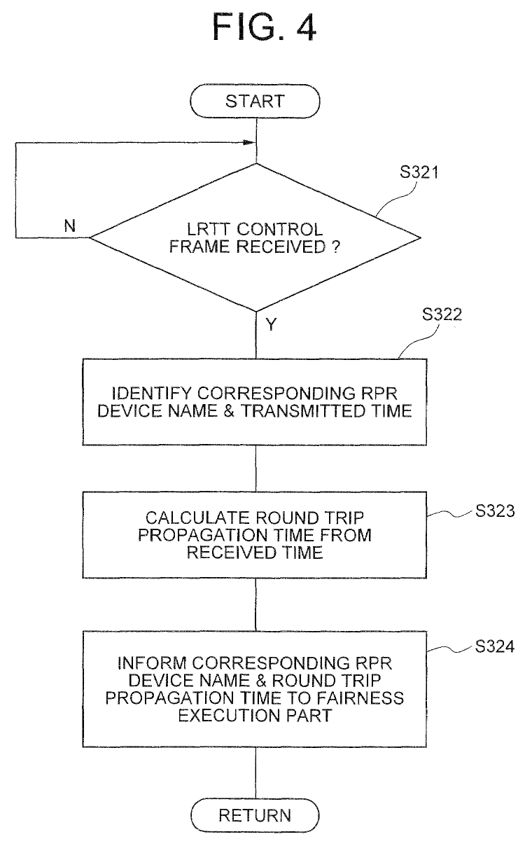

FIG. 4 shows the state of processing executed by the LRTT control frame receiver and the round trip propagation time calculator. FIG. 1 and FIG. 2 will be described together. Omitted herein is an explanation regarding the output control of the LRTT control frame that is outputted when there is a change in the structure of the RPR network 200. The LRTT control frame receiver 215 waits for the LRTT control frame (that has been transmitted from the receiver 215 itself) returned from one of the second-fourth. RPR devices 202₂-202₄ (step S321). Upon receiving the LRTT control frame (Y), the name of the RPR device 202 that has sent the LRTT control frame and the transmitted time written to the LRTT control frame are identified (step 322). However, it is not specifically necessary to identify the name of the RPR device 202 from the LRTT control frame itself, if the transmitted time of the LRTT control frame is different in each of the second-fourth RPR devices 202₂-202₄ and the round trip propagation time measuring device 211 holds information regarding the respective transmitted time and the devices in a related manner.

When the processing of step S322 is completed, the round trip propagation time calculator 214 calculates the round trip propagation time LRTT that is the time for which the LRTT control frame reaches the corresponding device among the second-fourth RPR devices 202₂-202₄ and returns therefrom according to the relation with the received time based on information sent from the LRTT control frame receiver 215 (step S323). Then, the roundtrip propagation time calculator 214 informs a pair of data, i.e. the name of the corresponding RPR device and the round trip propagation time LRTT, to the fairness execution part 212 (step S324). Thereafter, the LRTT control frame receiver 215 and the round trip propagation time calculator 214 return to step S321, and wait for a next LRTT control frame.

In the meantime, the fairness execution part 212 includes a table (not shown) that stores round trip propagation time LRTT for each of the second-fourth RPR devices 202₂-202₄. Upon receiving a notification with the pair of data, i.e. the name of the corresponding RPR device and the round trip propagation time LRTT, the fairness execution part 212 writes the latest round trip propagation time LRTT to the table having the name of the RPR device 202 as the key. Based on this, a fairness function defined in IEEE (The institute of Electrical and Electronics Engineers, Inc) 802.17 can be rebuilt.

Further, if necessary, a difference between the round trip propagation time of the RPR device 202 written earlier and the current round trip propagation time of the same RPR device 202 can be checked to know if there is a change in the signal transmission path in the SDH network 101.

As described above, the RPR device 202 of the exemplary embodiment uses the timer 218 to transmit the LRTT control frame regularly to measure the round trip propagation time. Thus, when there is a fault on the SDH network even though there is no change in the structure as the RPR network, it is possible to follow the change in the round trip propagation time between the RPR devices 202 and to achieve optimum operation as the RPR network 200.

In the exemplary embodiment, the first-fourth RPR devices 202₁-202₄ are arranged to surround the SDH network 100. However, it is not limited to the exemplary embodiment, and the total number of the RPR devices 202 may be any numbers as long as it is 2 or larger. Further, the network with a protection function on which the RPR network 200 is built is not limited to the SDH network 101. For example, the present invention can also be applied to Y.17etheps (Ethernet (registered trademark) Protection Switching) which is being standardized in ITU-T (International Telecommunications Union-Telecommunications Standardization Sector). Further, the ring-type network is not limited to the RPR network 200.

Furthermore, unlike the exemplary embodiment, the RPR network 200 can also recognize a change in the signal propagation path by making each of the first-fourth SDH devices 103₁-103₄ configuring the SDH network inform the change in the signal propagation path by the protection function to the corresponding first-fourth RPR devices 102₁-102₄. However, in such case, it is necessary to provide a device for performing notification to the SDH network 101 side, so that the system as a whole becomes complicated. Further, the RPR network according to the exemplary embodiment has such an advantage that the existing SDH network 101 can be used as it is.

Next, other exemplary embodiments of the invention will be described.

As a third exemplary embodiment of the invention, the ring-type network according to the first exemplary embodiment may be the ring-type network wherein each of the second nodes further includes: a structure change identifying device which identifies a change in a structure of the ring-like network configured with the plurality of second nodes; a changed-state measurement signal transmitting device which transmits a changed-state measurement signal for measuring round trip propagation time when the structure change identifying device identifies a change in the structure of the ring-like network; a changed-state measurement signal returning device which returns the changed-state measurement signal to the second node as a sender, when the changed-state measurement signal is transmitted from the changed-state measurement signal transmitting device belonging to the second node other than the own second node; a changed-state measurement signal receiving device which receives the changed-state measurement signal returned from the changed-state measurement signal returning device belonging to the second node other than the own second node; and a changed-state round trip propagation time measuring device which measures round trip propagation time of the changed-state measurement signal between the second nodes by finding a difference between received time of the changed-state measurement signal received at the changed-state measurement signal receiving device and transmitted time at which the changed-state measurement signal is transmitted from the changed-state measurement signal transmitting device.

As a fourth exemplary embodiment of the invention, the ring-type network according to the third exemplary embodiment may be the ring-type network wherein each of the second nodes includes a fairness executing device which executes a fairness function in communications by using the round trip propagation time between the second nodes measured respectively by the periodic-measurement round trip propagation time measuring device and the changed-state round trip propagation time measuring device.

As a fifth exemplary embodiment of the invention, the ring-type network according to the third exemplary embodiment may include a transmission arbitrating device which arbitrates signal transmissions, when there is contention in terms of time for sending signals between the changed-state measurement signal transmitting device and the changed-state measurement signal receiving device.

As a sixth exemplary embodiment of the invention, the ring-type network according to the first exemplary embodiment may include a protection function for enabling communications by changing the signal transmission paths between the first nodes so as to avoid a fault.

As a seventh exemplary embodiment of the invention, the ring-type network according to the first exemplary embodiment may be the ring-type network wherein the base network is an SDH (Synchronous Digital Hierarchy) network, and an RPR (Resilient Packet Ring) network as the ring-type network is built thereon.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A network system, comprising
a ring-type network in which a plurality of nodes for configuring a network are linked to each other, and
a base network that is capable of changing signal transmission paths between each of the nodes within the network, wherein
the nodes of the ring-type network perform signal transmission between the linked nodes, and monitor signal propagation time before and after a change in the path through which the signal transmission is performed.

2. The network system as claimed in claim 1, wherein the nodes monitor the signal propagation time by identifying a change in a structure of the ring-type network.

3. The network system as claimed in claim 1, wherein the nodes execute a communication fairness function by using data of the signal propagation time.

4. The network system as claimed in claim 1, wherein each of the nodes comprises:
a measurement signal transmitting device for transmitting a measurement signal for measuring a round trip propagation time to the base network;
a measurement signal receiving device for receiving the measurement signal that is returned from a partner node that is being linked thereto; and
a propagation time measuring device for measuring the round trip propagation time between the linked nodes based on information of time that is required for the measurement signal to make a round trip.

5. The network system as claimed in claim 4, wherein each of the nodes comprises a measurement signal returning device for returning the transmitted measurement signal to the partner node that is linked via the base network.

6. The network system as claimed in claim 4, wherein:
each of the nodes comprises a structure change identifying device which identifies a change in a structure of the ring-type network; and
the measurement signal transmitting device transmits the measurement signal based on identifying information from the structure change identifying device.

7. The network system as claimed in claim 1, wherein the base network comprises a protection function for enabling communications by changing the signal transmission paths between the nodes so as to avoid a fault.

8. The network system as claimed in claim 1, wherein the base network is an SDH (Synchronous Digital Hierarchy) network, and an RPR (Resilient Packet Ring) network as the ring-type network is built thereon.

9. A node used for configuring a network by being linked in a ring-type network, wherein:
signal transmission paths between each of a plurality of liked nodes can be changed by a base network; and
the nodes perform signal transmission between the linked nodes, and monitor signal propagation time before and after a change in the path through which the signal transmission is performed.

10. The node used for a ring-type network as claimed in claim 9, which monitors the signal propagation time by identifying a change in a structure of the ring-type network.

11. The node used for a ring-type network as claimed in claim 9, which executes a communication fairness function by using data of the signal propagation time.

12. The node used for a ring-type network as claimed in claim 9, comprising:
a measurement signal transmitting device for sending a measurement signal for measuring a round trip propagation time to the base network;
a measurement signal receiving device for receiving the measurement signal that is returned from a partner node that is being linked thereto; and
a propagation time measuring device for measuring the round trip propagation time between the linked nodes based on information of time that is required for the measurement signal to make a round trip.

13. The node used for a ring-type network as claimed in claim 12, comprising a measurement signal returning device for returning the transmitted measurement signal to the partner node that is linked via the base network.

14. The node used for a ring-type network as claimed in claim 12, comprising a structure change identifying device which identifies a change in a structure of the ring-type network, wherein
the measurement signal transmitting device transmits the measurement signal based on identifying information from the structure change identifying device.

15. A communication control method, using a ring-type network in which a plurality of nodes for configuring the network are linked to each other, and a base network that is capable of changing signal transmission paths between each of the nodes within the network, the method comprising:
performing signal transmission between the nodes linked within the ring-type network, and
monitoring signal propagation time before and after a change made by the base network in the path through which the signal transmission is performed.

16. The communication control method for a network as claimed in claim 15, wherein the signal propagation time is monitored by identifying a change in a structure of the ring-type network.

17. The communication control method for a network as claimed in claim 15, wherein a communication fairness function is executed by using data of the signal propagation time.

18. A communication control program for controlling communications by using a ring-type network in which a plurality of nodes for configuring a network are linked to each other, and using a base network that is capable of changing signal transmission paths between each of the nodes within the network, the program allowing a computer to execute a function of monitoring signal propagation time before and after a change made by the base network in the path through which the signal transmission is performed between the nodes that are linked within the ring-type network.
